(19) United States
(12) Patent Application Publication
(10) Pub. No.: US 2019/0347315 A1
(43) Pub. Date: Nov. 14, 2019

(54) METHODS AND SYSTEMS FOR RENDERING WEB PAGES WITH RESTRICTED FEATURES

(71) Applicant: INTERNATIONAL BUSINESS MACHINES CORPORATION, Armonk, NY (US)

(72) Inventors: Christopher J. HARDEE, Raleigh, NC (US); Sarbajit K. RAKSHIT, Kolkata (IN); Jeremy A. GREENBERGER, San Jose, CA (US)

(73) Assignee: INTERNATIONAL BUSINESS MACHINES CORPORATION, Armonk, NY (US)

(21) Appl. No.: 15/973,668

(22) Filed: May 8, 2018

(51) Int. Cl. G06F 17/22

(52) U.S. Cl. CPC G06F 17/2288; G06F 17/2247

(57) ABSTRACT

Embodiments for rendering web pages by one or more processors are described. Data associated with the performance of a first computing node rendering a web page is stored. A second computing node is detected rendering the web page after the first computing node renders the web page. The rendering of the web page by the second computing node is modified based on the stored data associated with the performance of the first computing node rendering the web page.

### BACKGROUND OF THE INVENTION

### Field of the Invention

The present invention relates in general to computing systems, and more particularly, to various embodiments for rendering web pages in such a way that some features thereof are restricted.

### Description of the Related Art

Some websites and/or web pages are “bad actors.” This is sometimes related to security concerns, but often the problem is that the pages are poorly designed and have badly written code. For example, the web pages may have poorly written Ajax, cache too much data, and/or have an excess of embedded content (e.g., multimedia content).

Such web pages often result in instability and/or an extreme use of resources by web browsers and/or the computing devices running the web browsers. As one example, some users may experience a web browser utilizing 2 gigabytes (GBs) or more of random-access memory (RAM), with seemingly no real reason for it.

### SUMMARY OF THE INVENTION

Various embodiments for rendering web pages by one or more processors are described. In one embodiment, by way of example only, a method for rendering web pages, again by one or more processors, is provided. Data associated with the performance of a first computing node rendering a web page is stored. A second computing node is detected rendering the web page after the first computing node renders the web page. The rendering of the web page by the second computing node is modified based on the stored data associated with the performance of the first computing node rendering the web page.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention; and

FIG. 4 is a flowchart diagram of an exemplary method for rendering web pages according to an embodiment of the present invention.

### DETAILED DESCRIPTION OF THE DRAWINGS

As discussed above, although some websites and/or web pages are “bad actors” due to security concerns, often the problem is that the pages are poorly designed and have badly written code. For example, the web pages may have poorly written Ajax, cache too much data, and/or have an excess of embedded content (e.g., multimedia content).

Such web pages often result in instability and/or an extreme use of resources by web browsers and/or the computing devices running the web browsers. As one example, some users may experience a web browser utilizing 2 gigabytes (GBs) or more of random-access memory (RAM), with seemingly no real reason for it.

To address these needs, some embodiments described herein provide methods and systems for monitoring the behavior and/or performance of web pages (e.g., how the web pages are rendered by web browsers and/or the performance of the respective computing devices while the web pages are rendered) to alter how the browsers handle those web pages in the future. The alterations may be stored and perhaps shared with/utilized by other users (e.g., individuals, instances of web browsers, computing devices, etc.).

Embodiments described herein may monitor various types of data when a first computing node (e.g., a browser and/or computing device) visits or renders a web page (or domain or subdomain). The data may be associated with the performance of the computing node while rendering the web page, such as performance degradation, excessive network traffic, how long the web page has been loaded, etc., as well as other events such as the browser stops responding (or “freezes up” or “crashes”) while the web page is loaded. The performance data (or history) for each web page is stored.

When the web page is rendered again (e.g., by the same computing node or a different computing node), the performance data for that web page is checked and used to determine whether or not the manner in which the web page is rendered should be modified or altered (e.g., compared to the manner in which previous computing nodes rendered it, compared to how it is “normally” rendered, etc.). For example, features and/or functions on the web page, such as web scripts and/or plug-ins, may be prevented from being utilized. Performance characteristics of the (second) computing node, such as memory (e.g., available memory), processor speed, and network connection speed, may also be used to determine which, if any, features on the web page should be restricted.

In particular, in some embodiments, a method, by one or more processors, for rendering web pages is provided. Data associated with the performance of a first computing node rendering a web page is stored. A second computing node rendering the web page is detected after the first computing node renders the web page. The rendering of the web page by the second computing node is modified based on the stored data associated with the performance of the first computing node rendering the web page.

Each of the first computing node and the second computing node may include a computing device, a software application, or a combination thereof. If each of the first computing node and the second computing node includes a computing device, the stored data associated with the performance of the first computing node rendering the web page may be associated with at least one of processor usage, memory usage, and network traffic.

The modifying of the rendering of the web page by the second computing node may include preventing at least one feature of the web page from being utilized during the rendering of the web page by the second computing node. The at least one feature of the web page may include at least one of a web script and a plug-in.

The first computing node may include a first computing device, and the second computing node may include a second computing device. The modifying the rendering of the web page by the second computing node may further be based on at least one performance characteristic of the second computing device.

It should be understood that as used herein, the term “computing node” (or simply “node”) may refer to a computing device, such as a mobile electronic device or a desktop computer, and/or an application, such as a web browser, etc., that is installed on a computing device. In other words, as used herein, examples of computing nodes include, for example, mobile phones, tablet devices, desktop computers or workstations, and/or various applications that are utilized by and/or installed on such computing devices.

In some embodiments, the methods and/or systems described herein may utilize “machine learning,” “cognitive modeling,” “predictive analytics,” and/or “data analytics,” as is commonly understood by one skilled in the art. Generally, these processes may include, for example, receiving and/or retrieving multiple sets of inputs, and the associated outputs, of one or more systems and processing the data (e.g., using a computing system and/or processor) to generate or extract models, rules, etc. that correspond to, govern, and/or estimate the operation of the system(s), or with respect to the embodiments described herein, users' feedback and/or changes in performance, with respect to, for example, the rendering of web pages, as described herein. Utilizing the models, the performance (or operation) of the system (e.g., utilizing/based on new inputs) may be predicted and/or the performance of the system may be optimized by investigating how changes in the input(s) effect the output(s).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment, such as cellular networks, now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

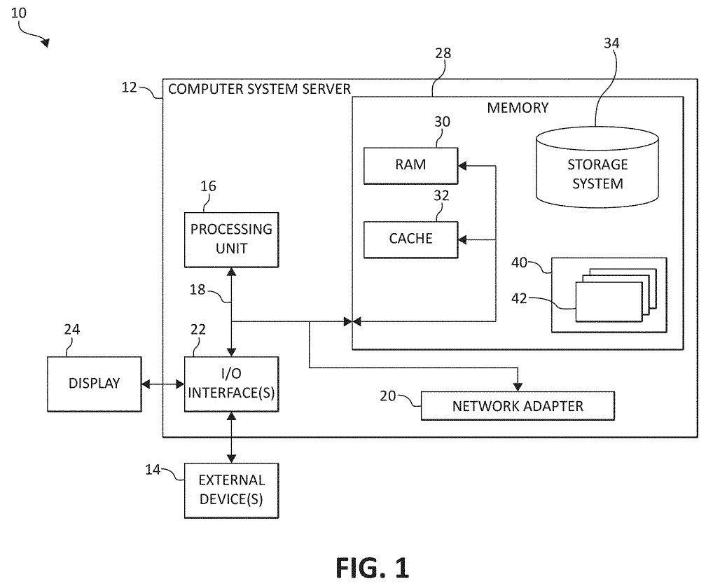

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 (and/or one or more processors described herein) is capable of being implemented and/or performing (or causing or enabling) any of the functionality set forth herein.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in, for example, personal computer systems, server computer systems, thin clients, thick clients, hand-held or laptop devices, multiprocessor systems, microprocessor-based systems, set top boxes, programmable consumer electronics, network PCs, mobile electronic devices such as mobile (or cellular and/or smart) phones, personal data assistants (PDAs), tablets, wearable technology devices, laptops, handheld game consoles, portable media players, etc., as well as computing systems in vehicles, such as automobiles, aircraft, watercrafts, etc. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

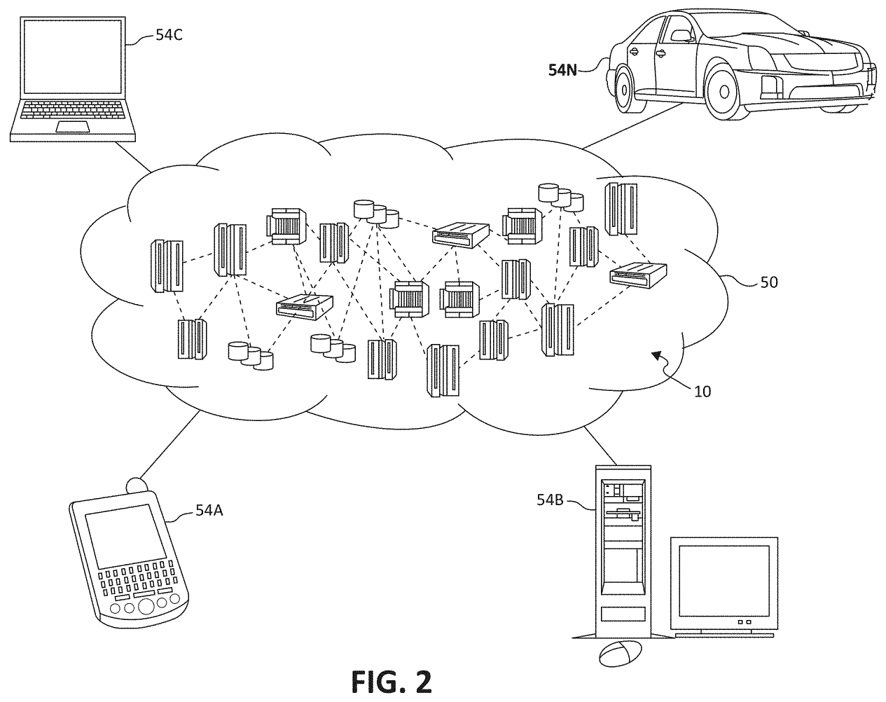

Referring now to FIG. 2, illustrative cloud computing environment 50 is depicted. As shown, cloud computing environment 50 comprises one or more cloud computing nodes 10 with which local computing devices used by cloud consumers, such as, for example, cellular telephone or PDA 54A, desktop computer 54B, and/or laptop computer 54C, and vehicles (e.g., automobiles, aircraft, watercraft, etc.) 54N may communicate.

Still referring to FIG. 2, nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

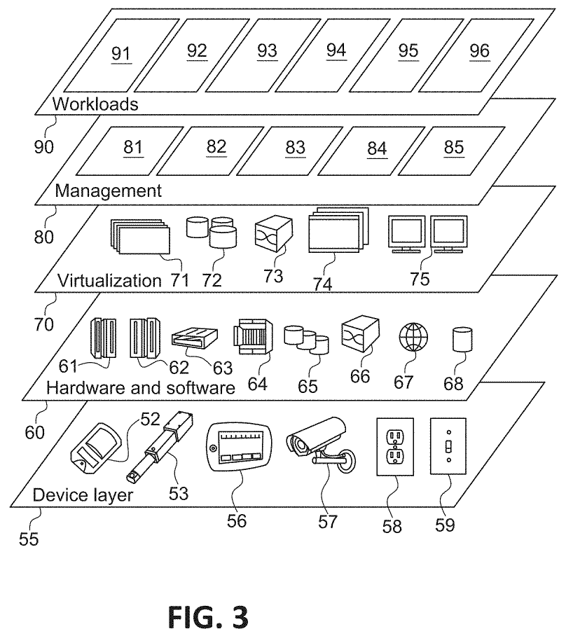

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to, various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for rendering web pages as described herein. One of ordinary skill in the art will appreciate that the workloads and functions 96 for rendering web pages may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As described above, some embodiments described herein provide methods and systems for monitoring the behavior and/or performance of web pages (e.g., how the web pages are rendered by web browsers and/or the performance of the respective computing devices while the web pages are rendered) to alter how browsers handle those web pages in the future. The behavior/performance and/or the alterations made may be stored and perhaps shared with/utilized by other users (e.g., other individuals, other instances of web browsers, other computing devices, etc.).

Generally, a first computing node (e.g., a browser and/or computing device) visits or renders a web page (or domain or subdomain). Data associated with, for example, the performance of the computing node while rendering the web page, such as performance degradation, excessive network traffic, how long the web page has been loaded, etc., as well as other events such as the browser stops responding (or “freezes up” or “crashes”) while the web page is loaded, is monitored. The performance data (or history) for each web page is stored (e.g., in a central database and/or on the computing device utilized to render/visit the web page).

When the web page is rendered again (e.g., by the same computing node or a different computing node), the performance data for that web page is checked and used to determine whether or not the manner in which the web page is rendered should be modified or altered. For example, features and/or functions on the web page, such as web scripts and/or plug-ins, may be prevented from being utilized. Performance characteristics of the (second) computing node, such as memory (e.g., available memory), processor speed, and network connection speed, may also be used to determine which, if any, features on the web page should be restricted.

In some embodiments, a first computing node is utilized (e.g., by a user) to render (or visit) a web page. The first computing node may be, for example, a web browser application and/or a computing device utilizing a web browser. While the first computing node renders the web page, various data is monitored and/or collected and stored. The data may be associated with the performance of the computing node, particularly when the performance degrades (e.g., to a certain degree while rendering the web page and/or technical details associated with the computing node rendering the web page). For example, the data may be associated with computing device performance (e.g., the performance of the computing device rendering the web page), such as memory (e.g., RAM) usage and/or processor usage (e.g., the percentage of the total RAM being utilized by the browser and/or the percentage of total processor speed/resources being utilized while the web page is being rendered). Threshold values (e.g., percentages) may be set, and when the thresholds are exceeded, the event(s) may be noted in the stored data. Also, performance characteristics of the computing node (e.g., hardware characteristics), such as processor speed, total memory, etc., may be stored. In some embodiments, the web browser utilized may employ separate processes for each page that is loaded (e.g., when multiple web pages are simultaneously loaded/rendered), as is commonly understood in the art, which may facilitate determining the resources utilized for each web page.

Additionally, the amount of network traffic may be tracked or monitored using the Hypertext Transfer Protocol (HTTP) referrer or other attributes of the HTTP requests/responses. As another example, how long a web page has been loaded may be monitored, which may be used to determine if there is a “leak” or an increase in performance degradation over time. Other events/data that may indicate excessive resources being utilized by a web page and/or a poorly designed/written web page may also be tracked and monitored. As another example, instances in which the web browser stops responding (e.g., “freezes”) while rendering particular web pages may be noted and stored. Such events may be averaged across multiple uses (e.g., visits to a particular web page and/or visits to multiple web pages) to determine the bad actor (though this process may be facilitated when the browser uses separate processes for each web page).

As described above, the data associated with the first computing node rendering the web page may be stored (e.g., in a central database, on the cloud, etc., and/or on a memory within the computing device used to render the web page). A second computing node then visits or renders the web page (e.g., the second computing node renders the web page after the first computing node). The second computing node may include a second computing device (e.g., a computing device different than that of the first computing node), which may be remote from the first computing node/device (e.g., at a different location, on a different network, etc.). However, it should be understood that the second computing node may refer to the same computing device as the first computing node, perhaps even utilizing the same browser. In this manner, it should be understood that the second computing node may be the same as the first computing node when the first computing node is again being used to render the web page (e.g., the same computing node being used to visit/render the same web page again).

When the second computing node is detected as rendering the web page (e.g., as the web page is being loaded or after the web page is loaded), the stored data is checked for performance data associated with that particular web page. For example, the web browser (and/or an extension (or add on) for the web browser) may send a request to, for example, the central database, cloud, etc., for any performance data related to the web page (or may simply check the appropriate memory on the computing device if the second computing node includes the same computing device as the first computing node). The performance data is then used to determine whether or not to make any modifications to the manner in which the second computing node renders the web page (e.g., to make any changes from the manner in which the web page is normally/usually rendered). In some embodiments, the modification(s) to the manner in which the web page is rendered may include preventing some features or functions of the web page from being loaded or utilized (e.g., restricting web scripts, plug-ins, embedded multimedia, etc.). As one example, if the stored performance data indicates performance degradation (e.g., excessive memory usage) over a predetermined threshold (e.g., 50% or any threshold that may be set as a system default), at least some of the features/functions of the web page may be prevented from being utilized.

In some embodiments, the disabled features may be re-enabled over time. For example, if during a single visit to the web page, the system detects that no significant performance degradation is being experienced as the disabled features are re-enabled, additional features may be re-enabled until the performance again degrades past the threshold(s). Further, features may be incrementally re-enabled over a longer period of time. For example, if the performance data collected by computing nodes indicates that the performance degradation is lessening with respect to a particular web page, more and more features may be re-enabled (e.g., for subsequent renderings of the web page by the same computing node or other computing nodes).

Additionally, performance characteristics (e.g., processor speed, total memory, network speed, history of network speed, etc.) of the second computing node may be taken into consideration in determining which and/or how many of the features of the web page should be restricted. For instance, in the event that a computing node is detected as having a significantly faster or more efficient processor compared to previous computing nodes (e.g., the computing nodes utilized to collect the data associated with the web page), a reduced number of features may be disabled when that particular computing node visits/renders the web page.

As indicated above, the performance data collected by one computing node may be collected and stored to be used by other computing nodes (e.g., crowdsourcing), as may any settings for thresholds that trigger actions (e.g., feature restriction) and the elements/features (e.g., particular web scripts, plug-ins, etc.) that are restricted from being utilized when particular web pages (or domains) are visited (or rendered). In some embodiments, the various features that are disabled may be selected by determining which of those features provide improved performance when they are disabled/restricted. For example, the elements on a web page that are enabled/disabled during normal operation may be randomized until the bad elements (e.g., those causing the performance degradation, freezing, etc.) are identified or determined. In the event a group of elements or library, such as an Ajax derivative or plug-ins, are determined to be a common problem, those elements may be disabled for all computing nodes (those utilizing the system described herein) or selected for disablement early in the process.

Additionally, reports of performance problems and the disablement of features may be reported by users (e.g., via electronic communications, such as email, or through a website) to an administrator and/or to an organization hosting a particular domain (e.g., web pages causing performance degradation). Any feedback provided by users may be utilized to improve the overall efficiency of the system. Further, in the event that a user's availability/activity may be predicted, such may be utilized to determine whether or not to allow certain features. For example, if a user has opened a web page on his/her computing device and then left the vicinity of the computer (e.g., to get coffee, do laundry, etc.), additional content may be loaded based on the user's predicted return to the computing device. In this way (e.g., regarding feedback and/or user behavior), as well as the disabling of features vs. changes in performance, cognitive learning may be utilized by the methods and systems described herein.

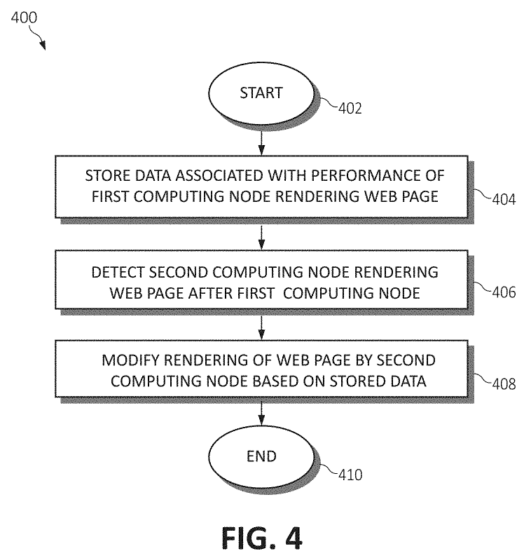

Turning to FIG. 4, a flowchart diagram of an exemplary method 400 for rendering web pages, according to some embodiments described herein, is provided. Method 400 begins (step 402) with, for example, a first computing node (or multiple computing nodes) rendering a web page (e.g., being used by a user to visit a web page, website, domain, etc.). The first computing node may be (or include) a computing device, a software application, or a combination thereof (e.g., a web browser installed on a computing device).

Data associated with the performance of the first computing node rendering the web page is stored (step 404). The stored data may include and/or be associated with at least one of processor usage, memory usage, and network traffic. In some embodiments, the stored data is collected from multiple (first) computing nodes rendering the same web page.

A second computing node rendering the web page is detected after the first computing node renders the web page (step 406). The second computing node may include a computing device and/or a software application (e.g., a web browser installed on a computing device). The second computing node may be a computing node different than the first computing node (e.g., the first computing node may include a first computing device, and the second computing node may include a second computing device), or alternatively, may be the same computing node as the first computing node (e.g., the same computing device and/or browser that was used in step 404 to collect the data).

The rendering of the web page by the second computing node is modified (e.g., from the manner in which it was rendered by the first computing node) based on the stored data associated with the performance of the first computing node rendering the web page (step 408). The modifying of the rendering of the web page by the second computing node may include preventing at least one feature, such as a web script and/or a plug-in, of the web page from being utilized during the rendering of the web page by the second computing node. The modifying the rendering of the web page by the second computing node may further be based on at least one performance characteristic of the second computing device (e.g., processor speed, total memory, network speed, etc. of the computing device).

Method 400 ends (step 410) with, for example, the web page being rendered by the second computing node in the modified manner. Additional performance data may be collected via the second computing node to detect if any additional changes to the manner in which the web page is rendered, have occurred (e.g., by the second computing node or subsequent computing nodes used to render the web page). Users may provide feedback (e.g., related to performance), which may be utilized in subsequent cycles.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by one or more processors, for rendering web pages comprising:
storing data associated with the performance of a first computing node rendering a web page such that the performance data corresponds to computing resources of the first computing node utilized to render the web page comprising a specific web page of a plurality of web pages;
detecting a second computing node rendering the web page after the first computing node renders the web page; and
modifying the rendering of the web page by the second computing node based on the stored data associated with the performance of the first computing node rendering the web page.

2. The method of claim 1, wherein each of the first computing node and the second computing node includes a computing device, a software application, or a combination thereof.

3. The method of claim 2, wherein each of the first computing node and the second computing node includes a computing device, and wherein the stored data associated with the performance of the first computing node rendering the web page is associated with at least one of processor usage, memory usage, and network traffic.

4. The method of claim 1, wherein the modifying of the rendering of the web page by the second computing node includes preventing at least one feature of the web page from being utilized during the rendering of the web page by the second computing node.

5. The method of claim 4, wherein the at least one feature of the web page includes at least one of a web script and a plug-in.

6. The method of claim 2, wherein the first computing node includes a first computing device, and the second computing node includes a second computing device.

7. The method of claim 6, wherein the modifying the rendering of the web page by the second computing node is further based on at least one performance characteristic of the second computing device.

8. A system for rendering web pages comprising:
at least one processor that
stores data associated with the performance of a first computing node rendering a web page;
detects a second computing node rendering the web page after the first computing node renders the web page such that the performance data corresponds to computing resources of the first computing node utilized to render the web page comprising a specific web page of a plurality of web pages; and
modifies the rendering of the web page by the second computing node based on the stored data associated with the performance of the first computing node rendering the web page.

9. The system of claim 8, wherein each of the first computing node and the second computing node includes a computing device, a software application, or a combination thereof.

10. The system of claim 9, wherein each of the first computing node and the second computing node includes a computing device, and wherein the stored data associated with the performance of the first computing node rendering the web page is associated with at least one of processor usage, memory usage, and network traffic.

11. The system of claim 8, wherein the modifying of the rendering of the web page by the second computing node includes preventing at least one feature of the web page from being utilized during the rendering of the web page by the second computing node.

12. The system of claim 11, wherein the at least one feature of the web page includes at least one of a web script and a plug-in.

13. The system of claim 9, wherein the first computing node includes a first computing device, and the second computing node includes a second computing device.

14. The system of claim 13, wherein the modifying the rendering of the web page by the second computing node is further based on at least one performance characteristic of the second computing device.

15. A computer program product for rendering web pages by one or more processors, the computer program product comprising a non-transitory computer-readable storage medium having computer-readable program code portions stored therein, the computer-readable program code portions comprising:
an executable portion that stores data associated with the performance of a first computing node rendering a web page such that the performance data corresponds to computing resources of the first computing node utilized to render the web page comprising a specific web page of a plurality of web pages;
an executable portion that detects a second computing node rendering the web page after the first computing node renders the web page; and
an executable portion that modifies the rendering of the web page by the second computing node based on the stored data associated with the performance of the first computing node rendering the web page.

16. The computer program product of claim 15, wherein each of the first computing node and the second computing node includes a computing device, a software application, or a combination thereof.

17. The computer program product of claim 16, wherein each of the first computing node and the second computing node includes a computing device, and wherein the stored data associated with the performance of the first computing node rendering the web page is associated with at least one of processor usage, memory usage, and network traffic.

18. The computer program product of claim 15, wherein the modifying of the rendering of the web page by the second computing node includes preventing at least one feature of the web page from being utilized during the rendering of the web page by the second computing node.

19. The computer program product of claim 18, wherein the at least one feature of the web page includes at least one of a web script and a plug-in.

20. The computer program product of claim 16, wherein the first computing node includes a first computing device, and the second computing node includes a second computing device.

21. The computer program product of claim 20, wherein the modifying the rendering of the web page by the second computing node is further based on at least one performance characteristic of the second computing device.
